(19) United States
(12) Patent Application Publication
(10) Pub. No.: US 2012/0274284 A1
(43) Pub. Date: Nov. 1, 2012

(54) System and Method for Controlling Voltage of Individual Battery Cells Within a Battery Pack

(75) Inventors: Paul W. Firehammer, Saline, MI (US); John H. Floros, Novi, MI (US)

(73) Assignee: A123 Systems, Inc., Waltham, MA (US)

(21) Appl. No.: 13/520,534

(22) PCT Filed: Jan. 4, 2011
(86) PCT No.: PCT/US11/20078

§ 371 Date: Jul. 11, 2012

Related U.S. Application Data
(60) Provisional application No. 61/292,271, filed on Jan. 5, 2010.

(51) Int. Cl. H02J 7/00

(52) U.S. Cl. 320/118

(57) ABSTRACT

Systems and methods for detecting and managing a plurality of cells within a battery pack supplying power to propel a vehicle are disclosed. One example method comprises, monitoring voltage of a plurality of battery cells of a battery pack, activating a power supply when a voltage of at least one battery cell of the plurality of battery cells exceeds a threshold, and draining a portion of charge from the at least one battery cell.

### TECHNICAL FIELD

The present application relates to controlling voltage of an individual battery cell within a battery pack supplying power to a vehicle.

### BACKGROUND AND SUMMARY

Lithium-ion batteries are being quickly accepted as reliable high density power storage devices, and motor vehicles, for example, may be powered at least in part by such a power storage device. In order to meet the amount of power required to run a motor vehicle, a plurality of lithium-ion battery cells may be assembled into a battery pack. As such, the power storage device (e.g., battery pack) may be comprised of more than one battery cell and each battery cell may have different charging characteristics. It may be desirable for each battery cell within a battery pack to store the same threshold limited charge as the performance of the battery pack may degrade when a single battery cell charges beyond a desired amount, for example. Thus, accurate monitoring and control of the state of charge of individual battery cells in a battery pack is needed.

Some present battery pack designs monitor and voltage balance battery cells when the battery pack is in operation. In particular, a battery control module (BCM) is configured to control passive balancing of individual battery cell voltages within a battery pack when the battery pack is capable of sourcing or sinking electrical power to a vehicle. The inventors herein have determined that such a system is less effective when the battery pack is not in operation, in sleep mode, or when battery cell stacks or modules are not assembled into a battery pack. During such conditions, the BCM may be deactivated or may not be in communication with the battery cell stacks. As a result, voltages of individual battery cells may increase above a threshold level while a BCM may be incapable of discharging the battery cells. For example, when a battery pack is placed in storage rather than installed in a vehicle, or when a vehicle is parked for an extended period of time, charge of individual battery cells may increase above a threshold level unless the BCM is powered. An alternate solution is to have the BCM powered while the battery is in storage or in a parked vehicle. However, the BCM may consume energy stored in the battery pack, thereby reducing the amount of time a battery pack can retain a desired level of charge while in a low power state. Also, this alternate solution does not address the instance where there is no BCM present.

The inventors herein have developed a method for controlling voltage of individual battery cells within a battery pack. In particular, the inventors have developed a method for managing voltage of a plurality of battery cells of a battery pack supplying power to propel a vehicle, comprising: monitoring voltage of a plurality of battery cells; activating a power supply when a voltage of at least one battery cell of said plurality of battery cells exceeds a threshold; activating a first microcontroller in response to said activation of said power supply; and in a first mode, said first microcontroller controlling draining a portion of charge from said at least one battery cell and storing battery cell event data; and in a second mode, said first microcontroller adjusting voltage of said at least one battery cell in response to instructions from a second microcontroller.

By activating a microcontroller that is coupled to a battery cell stack when battery cell voltage exceeds a threshold, it may be possible to control battery cell voltage when a BCM is unavailable. Further, when the BCM is available, the microcontroller can follow instructions from the BCM in accordance with conditions of a battery pack. Thus, the microcontroller coupled to the battery cell stack may be capable of reducing battery cell voltage when the battery cell voltage exceeds a threshold level, whether or not the battery cell stack is integrated into a battery pack, or whether or not a battery control module is active. Accordingly, the state of battery cells in a battery cell stack may be managed by the battery cell stack or module. Furthermore, a microcontroller coupled to a battery cell stack may communicate battery cell event data to the BCM after battery cell discharge events when the BCM is unavailable. In this way, the battery cell voltage may be controlled to less than a threshold level within a battery cell stack, whether or not a BCM is available.

The present description may provide several advantages. In particular, the approach allows for continuous monitoring of battery cell voltage even during conditions when the battery control system is partially powered down. Further, the approach may allow battery cells of a battery stack to be discharged even when a battery control module is unavailable to monitor and control battery cell discharge. Thus, the possibility of a battery cell retaining charge over a desired level may be reduced.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of a battery control system;

FIG. 2 shows a schematic view of an exemplary assembly of a battery cell stack;

FIG. 3 shows a schematic view of an exemplary battery cell;

FIG. 4 shows a schematic diagram of a voltage detection and control system;

FIG. 5 shows a schematic view of battery control system in a motor vehicle; and

FIG. 6 shows a flow chart illustrating a method for controlling the state of a battery cell.

### DETAILED DESCRIPTION OF THE DEPICTED EMBODIMENTS

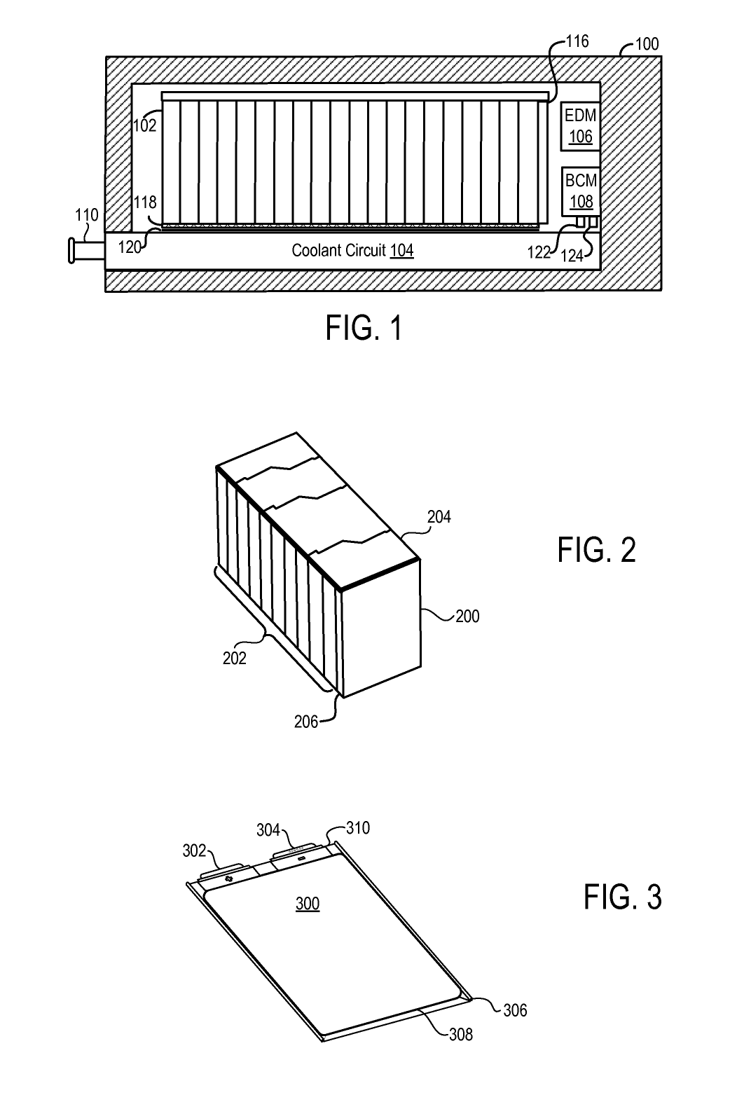

The present description is related to controlling voltage of individual battery cells within a battery pack supplying power to a vehicle. In one embodiment, the battery pack may be designed to include an enclosure and structure as is illustrated in FIG. 1. The battery pack may be comprised of one or more battery cell stacks, one of which is illustrated in FIG. 2. The battery cell stacks are comprised of a plurality of battery cells, one of which is illustrated in FIG. 3.

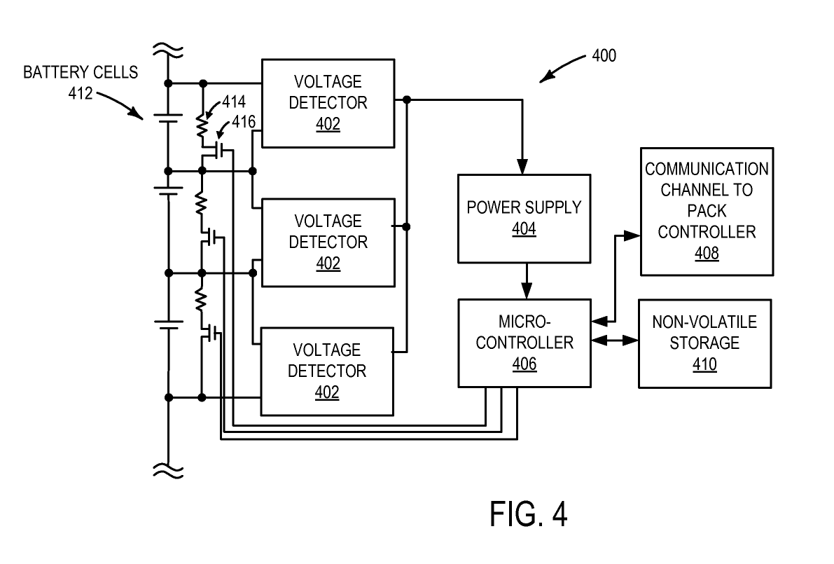

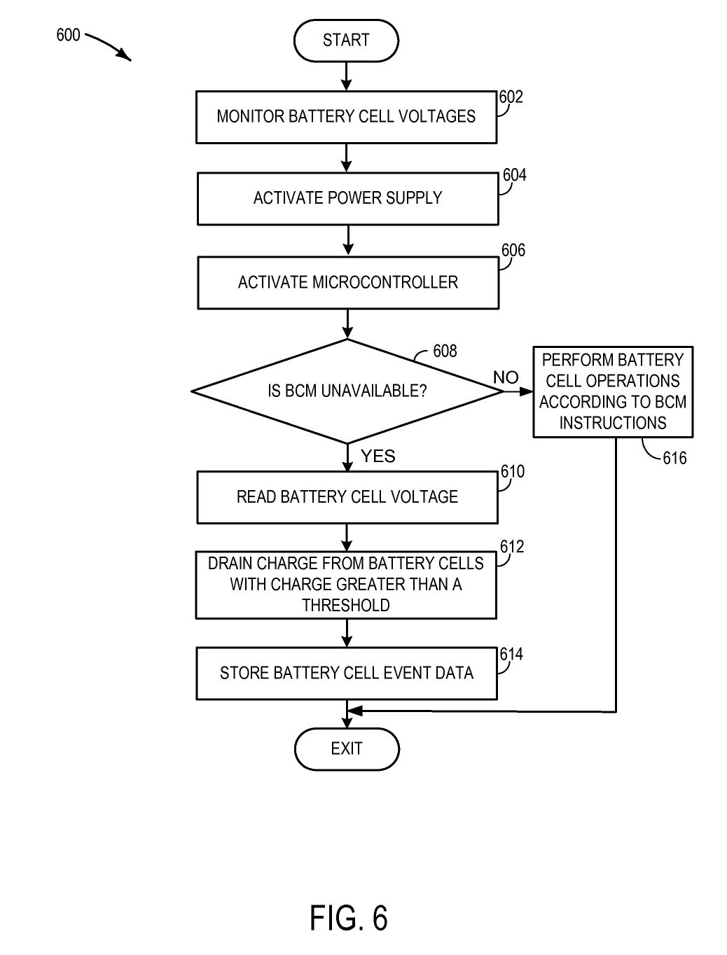

When a voltage of one or more of the battery cells comprising a battery stack in a battery pack exceeds a threshold, a power supply is activated which in turn activates a microcontroller. The voltage of battery cells may be continuously monitored by voltage detection circuitry once a monitor and balance board (MBB) is coupled to a battery cell stack. As will be described below with reference to FIGS. 4 and 6, the microcontroller on board the MBB may control the draining of charge via charge reducing circuitry from the one or more battery cells that exceed the threshold. The microcontroller may further communicate the battery cell event data to a BCM after a condition when a battery cell is discharged during a period when the BCM was unavailable to communicate instructions to the microcontroller. As such, conditions such as a battery charge exceeding a threshold may be reduced.

Referring now to FIG. 1, an example battery pack 100 is illustrated. Battery pack 100 includes battery cell stack 102, coolant circuit 104, electrical distribution module (EDM) 106, and BCM 108. In the depicted embodiment, coolant enters the coolant circuit at coolant connector 110. Further, coolant circuit 104 is in thermal communication with battery cell stack 102 via conductive grease 118 and a cold plate 120. When heat is generated by cell stack 102, coolant circuit 104 transfers the heat to a location outside of battery pack 100. In one embodiment, coolant circuit 104 may be in communication with a vehicle radiator when the battery pack is coupled in a vehicle.

Voltage of battery cells in battery cell stack 102 is monitored and balanced by monitor and balance board (MBB) 116, which may include a plurality of current, voltage, and other sensors. The EDM 106 controls the distribution of power from the battery pack to the battery load. In particular, EDM 106 contains contacts for coupling high voltage battery power to an external battery load such as an inverter. The BCM 108 controls ancillary modules within the battery pack such as the EDM and cell MBB, for example. Further, the BCM may be comprised of a microprocessor having random access memory, read only memory, input ports, real time clock, and output ports. Humidity sensor 122 and temperature sensor 124 provide internal environmental conditions of battery pack 100 to BCM 108.

Referring now to FIG. 2, an exemplary assembly of a battery stack 200 is shown. Battery stack 200 is comprised of a plurality of battery cells 202. In some embodiments, the battery cells may be lithium-ion battery cells, for example. In the example of FIG. 2, battery stack is comprised of ten battery cells. Although battery stack 200 is depicted as having ten battery cells, it should be understood that a battery stack may include more or less than ten cells. For example, the number of cells in a battery stack may be based on an amount of power desired from the battery stack. Within a battery cell stack, cells may be coupled in series to increase the battery cell stack voltage, or battery cells may be coupled in parallel to increase current capacity at a particular battery cell voltage. Further, a battery pack, such as battery pack 100 in FIG. 1, may be comprised of one or more battery stacks. As shown in FIG. 2, battery stack 200 further includes cover 204 which provides protection for battery bus bars (not shown) that route charge from the plurality of battery cells to output terminals of a battery pack. Battery stack 200 also includes one or more MBB 206. MBB 206 is shown at the front end of battery stack 200, but an additional MBB may be included at the back or opposite side of battery stack 200 depending on the battery stack configuration.

Turning now to FIG. 3, an exemplary embodiment of an individual battery cell is shown. Battery cell 300 includes cathode 302 and anode 304 for connecting to a bus (not shown). The bus routes charge from a plurality of battery plates to output terminals of a battery pack and is coupled to bus bar support 310. Battery cell 300 further includes prismatic cell 308 that contains electrolytic compounds. Prismatic cell 308 is in communication with heat sink 306. Heat sink 306 may be formed of a metal plate with the edges bent up 90 degrees on one or more sides to form a flanged edge. In the example of FIG. 3, the bottom edge, and sides, each include a flanged edge.

When a plurality of cells is put into a stack, the Prismatic cells are separated by a compliant pad (not shown). Thus, a battery cell stack is built in the order of heat sink, Prismatic cell, compliant pad, Prismatic cell, heat sink, and so on. One side of the heat sinks (e.g., flanged edges) may then contact the cold plate to improve heat transfer.

Referring now to FIG. 4, a schematic diagram of a voltage detection and management system 400 is shown. As depicted, the system includes a plurality of battery cells 412, voltage detectors 402, charge reducing circuitry for each battery cell, a power supply 404, non-volatile storage 410, and a microcontroller 406 that is in communication with a BCM by way of communication channel 408. Power supply 404 may be activated by voltage detectors or by the BCM.

In the example of FIG. 4, each of the plurality of battery cells 412 is shown in communication with a voltage detector 402 which includes voltage detection circuitry. Voltage detector circuits 402, power supply 404, microcontroller 406, non-volatile storage 410, load resistor 414, transistor switch 416, and communication channel 408 are incorporated into an MBB. Once the MBB is coupled to the battery stack, the battery cells are continuously monitored by the voltage detector circuits. Note that it is not necessary that the BCM is in communication with the MBB or for the battery cell stack to be integrated into a battery pack for the voltage detectors to operate. The voltage detector circuitry may be powered by the battery cells in the battery cell stack. Thus, the battery cell stack may become self regulating during some conditions. In one embodiment, voltage detector circuitry 402 may be comprised of a comparator referenced to a threshold voltage. If the input to the comparator exceeds the threshold voltage the comparator changes state from a low voltage output to a higher voltage output. The higher voltage output provides an indication that the particular battery cell is charged to a level greater than a desired level. Further, the outputs of the voltage detection circuits may be tied together in an OR arrangement so that a high level signal is present at a power supply located on the MBB whenever one of the plurality of battery cells is greater than a threshold level.

When a particular battery cell voltage or voltage range is detected, voltage detector circuitry 402 outputs a high level signal to power supply 404. For example, if the voltage of a battery cell is greater than a threshold value, voltage detector circuitry 402 may send a signal to power supply 404, thereby activating the power supply. Power supply 404 is in communication with microcontroller 406. As such, microcontroller 406 may be activated once power supply 404 is turned on. Microcontroller 406 may include digital inputs and outputs as well as one or more A/D inputs, read only memory, random access memory, and non-volatile storage.

As shown in FIG. 4, the microcontroller 406 is in communication with a battery pack controller via a communication channel 408. In one embodiment, communication channel 408 may be a CAN link. The battery pack controller may be a battery control module (BCM), as described above with reference to FIG. 1, for example. Via the communication channel 408, microcontroller 406 may communicate a variety of information to the BCM. As one example, the microcontroller 406 may update the BCM regarding battery cells that have been discharged while the BCM is unavailable. The BCM may be unavailable when it is without power or when it is carrying out other operations and may not have resources available to communicate with the microcontroller on board the MBB.

Microcontroller 406 may include non-volatile storage 410. As such, microcontroller 406 may save data regarding the plurality of battery cells to the non-volatile storage 410. For example, non-volatile storage 410 may save data regarding the voltage states of the battery cells including data regarding charge draining from the one or more battery cells that exceed the threshold voltage (e.g., amount of charge drained, number of times charge is drained from a particular battery cell, time and date of battery cell discharge etc.). In this manner, the microcontroller 406 may communicate battery cell information to the BCM when conditions are more favorable.

Once activated, microcontroller 406 may output a signal to turn on battery cell charge reducing circuitry which includes a load resistor 414 and a switch 416. For example, a digital output from the microcontroller 406 may close switch 416. As an example, switch 416 may be a transistor such as a field-effect transistor. Thus, when the switch 416 is closed, current may be allowed to flow through the charge reducing circuit. Battery cell charge may be dissipated by load resistor 414. In the example of FIG. 4, each battery cell of the plurality of battery cells is coupled in parallel with a switch (e.g., each battery cell is in communication with a switch). Once the charge of a particular battery cell is less than a threshold level, the output of voltage detector 402 coupled to the battery cell changes state to indicate that the charge of the particular battery cell is less than the desired level.

The appropriate switch (e.g., switch 416) may be set to an open condition by microcontroller 406 when battery cell voltage as measured by an A/D convertor and input to microcontroller 406 is less than the desired threshold voltage. Further, power supply 404 may be latched in an on condition by an output from the microcontroller (e.g., microcontroller 406). The microcontroller may hold a digital output high to keep the power supply activated until charge of each battery cell in the battery stack is less than a threshold. Further, the microcontroller may keep the power supply activated until it has completed a scheduled task that was initiated by activating power supply 404 (e.g., after writing battery cell event data to non-volatile storage).

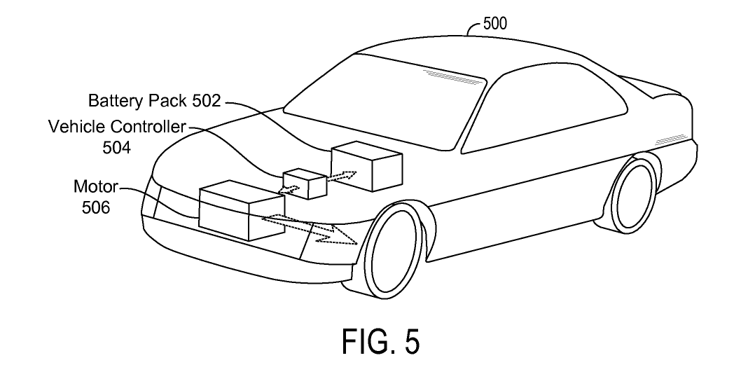

Turning to FIG. 5, a schematic view of a non-limiting application of the present system and method is shown. In particular, battery pack 502 is installed in a vehicle 500 for the purpose of supplying energy to propel vehicle 500 by way of electric motor 506. As shown in FIG. 5, vehicle controller 504 may facilitate communication between battery pack 502 and motor 506. In one embodiment, vehicle 500 may be propelled solely by electric motor 506. In another embodiment, vehicle 500 may be a hybrid vehicle that may be propelled by an electric motor and an internal combustion engine.

Thus, the system of FIGS. 1-5 provides for controlling voltage of individual battery cells within a battery pack supplying power to a vehicle, the system comprising a plurality of battery cells located in a battery pack, a voltage detection circuit for each battery cell comprising the plurality of battery cells, a power supply with an input for activating and deactivating the power supply, the input for activating and deactivating the power supply in communication with an output of the voltage detection circuit, and a microcontroller in communication with a plurality of switches that are configured to drain charge from individual battery cells comprising the plurality of battery cells. The system includes where the plurality of battery cells are lithium-ion battery cells or another known type of battery cell. The system includes where the microcontroller is in communication with a battery control module, and where the battery control module is in communication with one or more battery cell stack monitoring boards. Thus, the system can include a variety of modules for adjusting battery cell voltage. In some examples, each of the plurality of switches is a transistor such as a field effect transistor or a bipolar transistor. The system also includes where each of the plurality of switches is in communication with a load resistor. The load resistors may be coupled to the switches to drain charge from the battery cells. The system includes where each of the plurality of switches is coupled in parallel with a battery cell of the plurality of battery cells. By placing a switch in parallel with a battery cell, charge can be drained from one battery cell without discharging a second battery cell that is in series with the other battery cell. The system may also include a microcontroller that includes non-volatile storage.

The system of FIGS. 1-5 also provides for controlling voltage of individual battery cells of a battery cell stack, the system comprising a battery cell stack comprising a plurality of battery cells, an electronic module coupled to said battery cell stack, a plurality of voltage detection circuits for monitoring said plurality of battery cells, said electronic module comprising said plurality of voltage detection circuits; a power supply with an input for activating and deactivating said power supply, said input for activating and deactivating said power supply in communication with outputs of said plurality of voltage detection circuits, said electronic module comprising said power supply, and battery cell charge reducing circuitry in communication with said power supply and at least one battery cell of said plurality of battery cells, said electronic module comprising said battery cell charge reducing circuitry. The system also includes where the plurality of battery cells are lithium-ion battery cells or another known type of battery cell. The system further includes where the battery cell charge reducing circuitry includes a load resistor. Battery charge may be dissipated by the load resistor. The system also includes where the battery cell charge reducing circuitry includes a switch. In one example, the switch is a transistor. The system also include where the battery cell charge reducing circuitry is in communication with a battery control module.

Referring now to FIG. 6, a flow chart illustrating a method 600 for controlling voltage in at least one battery cell within a battery pack, such as battery pack 100 in FIG. 1, is shown. Specifically, the method monitors battery cell voltages and drains charge from battery cells that are above a threshold value.

At 602 of method 600, battery cell voltages are monitored. The voltage of each battery cell may be monitored by voltage detecting circuitry for each battery cell as described above with reference to FIG. 4, for example. Individual battery cell voltages are monitored as soon as an MBB is coupled to a battery cell stack.

At 604, a power supply on board the MBB is activated if one or more battery cell voltages are greater than a threshold value. As discussed above with reference to FIG. 4, the power supply may be activated when a single battery cell voltage in a battery cell stack exceeds a threshold level. Once the power supply is turned on, the microcontroller is activated at 606 of method 600.

Like the power supply, the microcontroller is coupled to the MBB which is coupled to the battery cell stack. Once the microcontroller is powered up, it attempts to communicate with a BCM to receive operating instructions. In one example, the microcontroller attempts to communicate to the BCM by way of a CAN. If the microcontroller can establish communication with the BCM routine 600 proceeds to 616. Otherwise, routine 600 proceeds to 610.

At 610, routine 600 reads the battery cell voltage values of each battery cell. In particular, battery cell voltage is read by an A/D channel and moved into memory of the microcontroller. The battery cell voltages may be sequentially read beginning from the first battery cell to the last, or the battery cell voltages may be captured by reading the battery cell voltages in a different order. After reading the battery cell voltages routine 600 proceeds to 612.

At 612, routine 600 proceeds to drain battery cells having charge greater than a threshold. Battery cell charge is drained by activating an output of a microcontroller. For example, if charge of battery cell number three of a battery cell stack is greater than a threshold level, the microcontroller activates an output which activates a switch that couples a load resistor to the battery cell that is charged above a threshold. While the battery cell is being discharged, the microcontroller may monitor the battery cell voltage via an A/D convertor so that the charge reducing network can be uncoupled from the battery cell when the battery cell voltage is less than the threshold voltage. After discharging each battery cell that is charged above a threshold, routine 600 proceeds to 614.

At 614, routine 600 stores battery cell event data for battery cells that were charged above a threshold level. Battery cell event data may include battery cell voltage before and after battery cell discharge, time and date of battery cell discharge, and operating conditions within the battery pack enclosure (e.g., battery pack enclosure temperature, battery pack humidity). The battery cell event data is stored to non-volatile storage so that the battery event data is available at a later time if the MBB microcontroller is deactivated before communications are established between the MBB microcontroller and the BCM controller.

In this manner, the amount of charge stored in individual battery cells within a battery pack may be monitored and regulated. As described above, each battery cell may be in communication with a voltage detector. In response to a battery cell voltage greater than a threshold, the voltage detector outputs a signal to activate a power supply which in turn activates a microcontroller. The microcontroller then reads battery cell voltages and closes a switch in a charge draining circuit that is in communication with the battery cell that is storing charge above a threshold level. The closed switch causes charge to be drained from the battery cell. The microcontroller also stores battery event data to non-volatile memory so that the data can be reported to the BCM at a later time. Thus, the charge of battery cells of a battery stack can be continuously monitored and regulated even though the battery cell stack may not be integrated into a battery pack or even though the battery cell stack is in a battery pack that is not in an active state such as when the battery control system is in an off state. Further, because power is utilized selectively to control battery cell voltage, power consumption within the battery pack may be reduced.

The method of FIG. 6 provides for managing voltage of a plurality of cells of a battery pack supplying power to propel a vehicle. The method includes monitoring voltage of a plurality of battery cells of a battery pack, activating a power supply when a voltage of at least one battery cell of said plurality of battery cells exceeds a threshold, and draining a portion of charge from said at least one battery cell. The method also includes where the draining of a portion of charge from the at least one battery cell is controlled by a microcontroller. In one example, the microcontroller may selectively drain charge in response to operating conditions of the battery pack. The power supply can active the microcontroller so that the microcontroller does not have to stay continuously powered. The method includes where the microcontroller activates at least a switch to perform the draining of the portion of charge from the at least one battery cell. The switch may be coupled to a load resistor to dissipate battery cell charge. The method also includes where the microcontroller communicates battery cell event data of said plurality of battery cells to a battery control module. Thus, battery cell conditions stored in the battery control module can be updated even if the battery control module is not operating at selected times. The method further includes where the microcontroller saves battery cell event data related to the draining of the portion of charge from the at least one battery cell to non-volatile storage. The method also includes where the microcontroller includes an output for draining charge from each of said plurality of battery cells.

The method of FIG. 6 also provides for managing voltage of a plurality of cells of a battery pack supplying power to propel a vehicle, comprising individually monitoring voltage of a plurality of battery cells of a battery pack via a plurality of voltage detection circuits, with each battery cell coupled to a voltage detection circuit, activating a power supply when a monitored individual voltage of a voltage detection circuit of at least one battery cell of said plurality of battery cells exceeds a threshold, the power supply activated via an input of the power supply, and draining a portion of charge from said at least one battery cell by selectively activating switches coupled to individual battery cells.

The method of FIG. 6 also provides for managing voltage of a plurality of cells of a battery pack supplying power to propel a vehicle. The method comprises monitoring voltage of a plurality of battery cells, activating a power supply when a voltage of at least one battery cell of said plurality of battery cells exceeds a threshold, activating a first microcontroller in response to said activation of said power supply, and in a first mode, said first microcontroller draining a portion of charge from said at least one battery cell and storing battery cell event data, and in a second mode, said first microcontroller adjusting voltage of said at least one battery cell in response to instructions from a second microcontroller. The method includes where a battery control module comprises the second microcontroller. The method of claim 22, wherein during said first mode, said second microcontroller is unavailable to communicate commands to said first microcontroller. The method includes where the first microcontroller includes an output for draining charge from each of the plurality of battery cells. The method also includes where the first microcontroller, the power supply, and the plurality of battery cells are electrically coupled.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for controlling voltage of individual battery cells within a battery pack supplying power to a vehicle, comprising:
a plurality of battery cells located in a battery pack;
a voltage detection circuit for each battery cell comprising said plurality of battery cells;
a power supply with an input for activating and deactivating said power supply, said input for activating and deactivating said power supply in communication with an output of said voltage detection circuit; and
a microcontroller in communication with a plurality of switches that are configured to drain charge from individual battery cells comprising said plurality of battery cells.

2. The system of claim 1, wherein said plurality of battery cells are lithium-ion battery cells.

3. The system of claim 1, wherein said microcontroller is in communication with a battery control module, said battery control module in communication with one or more battery cell stack monitoring boards.

4. The system of claim 1, wherein each of said plurality of switches is a transistor.

5. The system of claim 4, wherein each of said plurality of switches is in communication with a load resistor.

6. The system of claim 5, wherein each of said plurality of switches is coupled in parallel with a battery cell of said plurality of battery cells.

7. The system of claim 1, wherein said microcontroller includes non-volatile storage.

8. A system for controlling voltage of individual battery cells of a battery cell stack, comprising:
a battery cell stack comprising a plurality of battery cells;
an electronic module coupled to said battery cell stack;
a plurality of voltage detection circuits for monitoring said plurality of battery cells, said electronic module comprising said plurality of voltage detection circuits;
a power supply with an input for activating and deactivating said power supply, said input for activating and deactivating said power supply in communication with outputs of said plurality of voltage detection circuits, said electronic module comprising said power supply; and
battery cell charge reducing circuitry in communication with said power supply and at least one battery cell of said plurality of battery cells, said electronic module comprising said battery cell charge reducing circuitry.

9. The system of claim 8, wherein said plurality of battery cells are lithium-ion battery cells.

10. The system of claim 8, wherein said battery cell charge reducing circuitry includes a load resistor.

11. The system of claim 8, wherein battery cell charge reducing circuitry includes a switch.

12. The system of claim 11, wherein said switch is a transistor.

13. The system of claim 8, wherein said battery cell charge reducing circuitry is in communication with a battery control module.

14. A method for managing voltage of a plurality of cells of a battery pack supplying power to propel a vehicle, comprising:
monitoring voltage of a plurality of battery cells of a battery pack;
activating a power supply when a voltage of at least one battery cell of said plurality of battery cells exceeds a threshold; and
draining a portion of charge from said at least one battery cell.

15. The method of claim 14, wherein said draining of a portion of charge from said at least one battery cell is controlled by a microcontroller.

16. The method of claim 14, wherein said power supply activates a microcontroller.

17. The method of claim 16, wherein said microcontroller activates at least a switch to perform said draining of said portion of charge from said at least one battery cell.

18. The method of claim 16, wherein said microcontroller communicates battery cell event data of said plurality of battery cells to a battery control module.

19. The method of claim 16, wherein said microcontroller saves battery cell event data related to said draining of said portion of charge from said at least one battery cell to non-volatile storage.

20. The method of claim 16, wherein said microcontroller includes an output for draining charge from each of said plurality of battery cells.
